(19) United States
(12) Patent Application Publication
(10) Pub. No.: US 2026/0270339 A1
(43) Pub. Date: Sep. 10, 2026

(54) AIR EXTRACTION TYPE MOBILE PHONE WATERPROOF BAG

(71) Applicant: GINNINI TECHNOLOGY LIMITED, Hong Kong (CN)

(72) Inventor: Xiong JIE, Hong Kong (CN)

(73) Assignee: GINNINI TECHNOLOGY LIMITED, Hong Kong (CN)

(21) Appl. No.: 19/317,103

(22) Filed: Sep. 2, 2025

(30) Foreign Application Priority Data
Mar. 10, 2025 (CN) 202520408943.1

(51) Int. Cl. H04M 1/18

(52) U.S. Cl. CPC H04M 1/18

(57) ABSTRACT

An air-extraction waterproof mobile phone bag includes a waterproof mobile phone bag body, a transparent plastic film and a manual air-extracting pump. An opening is disposed on one side of the waterproof mobile phone bag body and is provided with a multi-sealing structure; the transparent plastic film is in closed connection with the waterproof mobile phone bag body. When a mobile phone is placed into the waterproof mobile phone bag body, screen and camera positions of the mobile phone correspond to the transparent plastic film; the manual air-extracting pump is disposed on the waterproof mobile phone bag body, and is pressed to discharge air inside the waterproof mobile phone bag body.

### CROSS-REFERENCE TO RELATED APPLICATIONS

This application claims priority to Chinese Patent Application No. 202520408943.1, filed on Mar. 10, 2025, the content of which is incorporated herein by reference in its entirety.

### TECHNICAL FIELD

The present disclosure relates to a waterproof mobile phone bag, in particular to an air-extraction waterproof mobile phone bag.

### BACKGROUND

In modern life, mobile phones have become an indispensable device in people's daily life. However, with the increase of outdoor activities, the demand for mobile phones to be used in water or humid environment also increases day by day. There are some shortcomings in the traditional waterproof mobile phone bags in this respect, mainly including the following aspects.

Lots of traditional waterproof mobile phone bags are sealed only through a simple zipper or a single seal such that there exists a large hidden danger in waterproof performance when these bags are used underwater or in a humid environment, which easily leads to penetration of moisture, damaging the mobile phone.

It is not convenient enough to use side buttons of a mobile phone for traditional waterproof bag users, which affects the user experience. At the same time, the air inside lots of waterproof bags cannot be discharged effectively, resulting in insufficient contact between the mobile phone and inner films of the bag, which affects the photographing effect and touch control performance.

### SUMMARY

The technical problem to be solved by the present disclosure is to provide an air-extraction waterproof mobile phone bag, so as to solve the problems in the background art.

The air-extraction waterproof mobile phone bag of the present disclosure is realized by the following technical solution, including a waterproof mobile phone bag body, a transparent plastic film, and a manual air-extracting pump; an opening is disposed on one side of the waterproof mobile phone bag body and is provided a multi-sealing structure; the transparent plastic film is in closed connection with the waterproof mobile phone bag body, when a mobile phone is placed into the waterproof mobile phone bag body, screen and camera positions of the mobile phone all correspond to the transparent plastic film; the manual air-extracting pump is disposed on the waterproof mobile phone bag body, and is pressed to discharge air inside the waterproof mobile phone bag body.

As a preferred technical solution, the other side of the waterproof mobile phone bag body is in an arc structure to press a button on a side of the mobile phone.

As a preferred technical solution, the multi-sealing structure includes a first sealing strip and a second sealing strip; the first sealing strip and the second sealing strip are disposed at the opening of the waterproof mobile phone bag body in sequence, and are extruded to seal the opening of the waterproof mobile phone bag body.

As a preferred technical solution, a Velcro adhesive surface is disposed on a front side at one side of the waterproof mobile phone bag body, and the Velcro adhesive surface is located on one side of the multi-sealing structure; a Velcro wool surface is disposed on a back side at one side of the waterproof mobile phone bag body, and the Velcro wool surface is located on the other side of the multi-sealing structure; and the opening of the waterproof mobile phone bag body is wound such that the Velcro adhesive surface and the Velcro wool surface are bonded together to further enhance waterproof performance.

As a preferred technical solution, a first lanyard port is disposed above the waterproof mobile phone bag body, and a second lanyard port is disposed below the waterproof mobile phone bag body.

As a preferred technical solution, a filleted corner is disposed around the waterproof mobile phone bag body, respectively.

The present disclosure has the following beneficial effects.

According to the present disclosure, a combination of a first sealing strip with a second sealing strip is adopted to enhance waterproof performance; by extruding the sealing strips, the opening of the waterproof mobile phone bag body can be ensured to be sealed effectively to prevent moisture invasion. Moreover, on the basis of the multi-sealing structure, the sealing effect is further improved by bonding a Velcro adhesive surface with a Velcro wool surface; further, by winding the opening, the bonding of the Velcro can achieve tighter closure and enhance the waterproof performance.

The present disclosure enables the user to discharge the air inside the bag conveniently through the manual air-extracting pump, thus ensuring that the mobile phone is attached to the transparent plastic film.

The arc structure on one side of the waterproof mobile phone bag body of the present disclosure makes it more convenient for users to use side buttons of the mobile phone.

### BRIEF DESCRIPTION OF THE DRAWINGS

To describe the technical solutions in the embodiments of the present disclosure or in the prior art more clearly, the drawings required for describing the embodiments or the prior art will be described briefly below. Obviously, the drawings in the following description are merely some embodiments of the present disclosure. Those skilled in the art could further obtain other drawings according to these drawings without any inventive efforts.

FIG. 1 is a schematic diagram showing a three-dimensional structure according to the present disclosure.

FIG. 2 is a schematic diagram showing an explosion structure according to the present disclosure.

### DETAILED DESCRIPTION OF THE EMBODIMENTS

All the features, methods or steps of processes disclosed in the present description, except mutually exclusive features and/or steps, can be combined in any way.

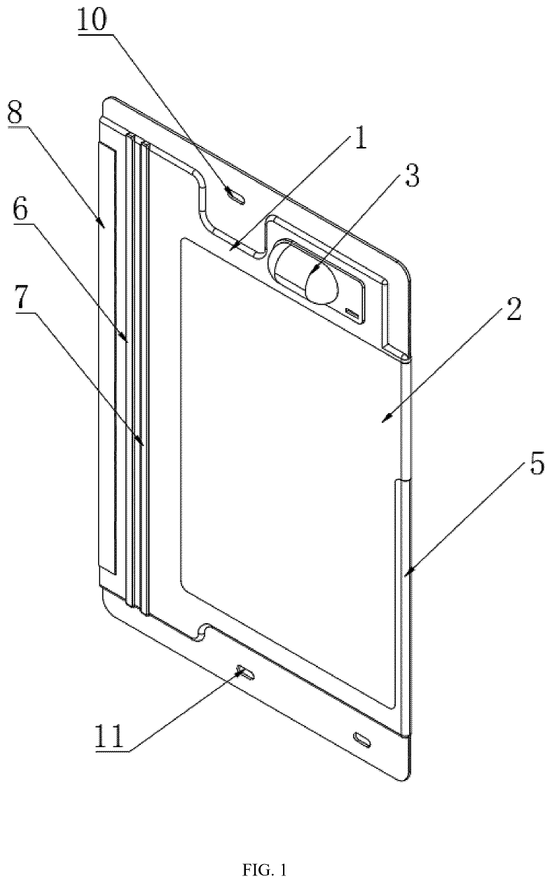

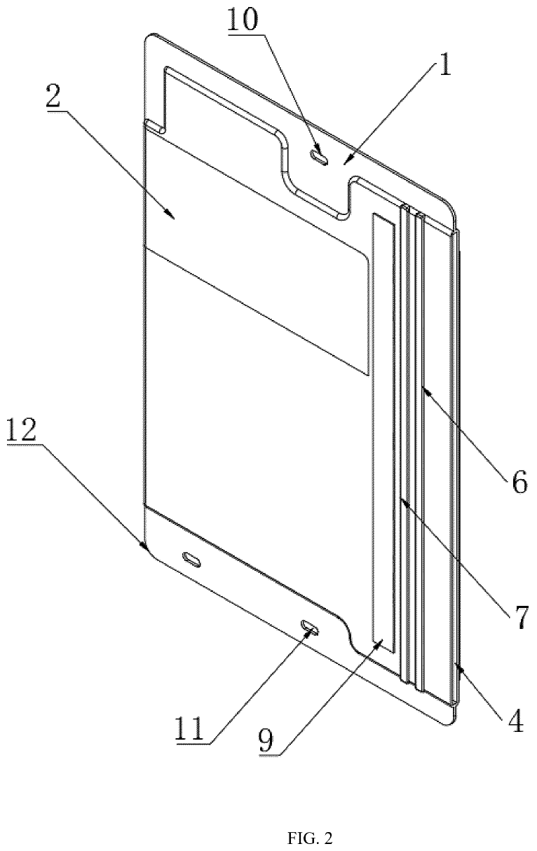

As shown in FIGS. 1-2, an air-extraction waterproof mobile phone bag of the present disclosure includes a waterproof mobile phone bag body 1, a transparent plastic film 2, and a manual air-extracting pump 3.

An opening 4 is disposed on one side of the waterproof mobile phone bag body 1 and is provided a multi-sealing structure; the transparent plastic film 2 is in closed connection with the waterproof mobile phone bag body 1, when a mobile phone is placed into the waterproof mobile phone bag body 1, screen and camera positions of the mobile phone all correspond to the transparent plastic film 2; the manual air-extracting pump 3 is disposed on the waterproof mobile phone bag body 1, and is pressed to discharge air inside the waterproof mobile phone bag body 1.

In order to facilitate pressing buttons, in this embodiment, the other side of the waterproof mobile phone bag body 1 is in an arc structure 5 to press a button on a side of the mobile phone.

In order to achieve the sealing effect, in this embodiment, the multi-sealing structure includes a first sealing strip 6 and a second sealing strip 7.

The first sealing strip 6 and the second sealing strip 7 are disposed at the opening 4 of the waterproof mobile phone bag body 1 in sequence, and are extruded to seal the opening 4 of the waterproof mobile phone bag body 1.

To further enhance the sealing effect, in this embodiment, a Velcro adhesive surface 8 is disposed on a front side at one side of the waterproof mobile phone bag body 1, and the Velcro adhesive surface 8 is located on one side of the multi-sealing structure.

A Velcro wool surface 9 is disposed on a back side at one side of the waterproof mobile phone bag body 1, and the Velcro wool surface 9 is located on the other side of the multi-sealing structure.

The opening 4 of the waterproof mobile phone bag body 1 is wound such that the Velcro adhesive surface 8 and the Velcro wool surface 9 are bonded together to further enhance waterproof performance.

In order to facilitate carrying, in this embodiment, a first lanyard port 10 is disposed above the waterproof mobile phone bag body 1, and a second lanyard port 11 is disposed below the waterproof mobile phone bag body 1.

To improve the aesthetic appearance, in this embodiment, filleted corners 12 are disposed around the waterproof mobile phone bag body 1.

What is described above are merely detailed embodiments of the present disclosure, but are not construed as limiting the scope of protection of the present disclosure. Any change or replacement envisaged without any inventive efforts shall fall within the scope of protection of the present disclosure. Therefore, the scope of protection of the present disclosure shall be subjected to the scope of protection defined in the claims.

What is claimed is:

1. An air-extraction waterproof mobile phone bag, comprising a waterproof mobile phone bag body, a transparent plastic film, and a manual air-extracting pump;
wherein an opening is disposed on one side of the waterproof mobile phone bag body and is provided a multi-sealing structure;
the transparent plastic film is in closed connection with the waterproof mobile phone bag body, when a mobile phone is placed into the waterproof mobile phone bag body, screen and camera positions of the mobile phone all correspond to the transparent plastic film; and
the manual air-extracting pump is disposed on the waterproof mobile phone bag body, and is pressed to discharge air inside the waterproof mobile phone bag body.

2. The air-extraction waterproof mobile phone bag according to claim 1, wherein the other side of the waterproof mobile phone bag body is in an arc structure to press a button on a side of the mobile phone.

3. The air-extraction waterproof mobile phone bag according to claim 1, wherein the multi-sealing structure comprises a first sealing strip and a second sealing strip; and
the first sealing strip and the second sealing strip are disposed at the opening of the waterproof mobile phone bag body in sequence, and are extruded to seal the opening of the waterproof mobile phone bag body.

4. The air-extraction waterproof mobile phone bag according to claim 1, wherein a Velcro adhesive surface is disposed on a front side at one side of the waterproof mobile phone bag body, and the Velcro adhesive surface is located on one side of the multi-sealing structure;
a Velcro wool surface is disposed on a back side at one side of the waterproof mobile phone bag body, and the Velcro wool surface is located on the other side of the multi-sealing structure; and
the opening of the waterproof mobile phone bag body is wound such that the Velcro adhesive surface and the Velcro wool surface are bonded together to enhance waterproof performance.

5. The air-extraction waterproof mobile phone bag according to claim 1, wherein a first lanyard port is disposed above the waterproof mobile phone bag body, and a second lanyard port is disposed below the waterproof mobile phone bag body.

6. The air-extraction waterproof mobile phone bag according to claim 1, wherein filleted corners are disposed around the waterproof mobile phone bag body.
